(19) United States
(12) Patent Application Publication
(10) Pub. No.: US 2015/0161999 A1
(43) Pub. Date: Jun. 11, 2015

(54) MEDIA CONTENT CONSUMPTION WITH INDIVIDUALIZED ACOUSTIC SPEECH RECOGNITION

(71) Applicants: Ravi Kalluri, San Jose, CA (US); Erwin Goesnar, Daly City, CA (US); Suri B. Medapati, San Jose, CA (US)

(72) Inventors: Ravi Kalluri, San Jose, CA (US); Erwin Goesnar, Daly City, CA (US); Suri B. Medapati, San Jose, CA (US)

(21) Appl. No.: 14/101,088

(22) Filed: Dec. 9, 2013

(51) Int. Cl. G10L 15/22

(52) U.S. Cl. CPC G10L 15/22; G10L 2015/223

(57) ABSTRACT

Apparatuses, methods and storage medium associated with content consumption, are disclosed herein. In embodiments, the apparatus may include a presentation engine to play the media content; and a user interface engine to facilitate a user in controlling the playing of the media content. The user interface engine may include a user identification engine to acoustically identify the user; an acoustic speech recognition engine to recognize speech in voice input of the user, using an acoustic speech recognition model specifically trained for the user, and a user command processing engine to process recognized speech as user commands. Other embodiments may be described and/or claimed.

### TECHNICAL FIELD

The present disclosure relates to the field of media content consumption, in particular, to apparatuses, methods and storage medium associated with consumption of media content that includes individualized acoustic speech recognition.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and the manners the contents are consumed. Today, multi-media contents may be available from fixed medium (e.g., Digital Versatile Disk (DVD)), broadcast, cable operators, satellite channels, Internet, and so forth. User may consume contents with a wide range of content consumption devices, such as, television set, tablet, laptop or desktop computer, smartphone, or other stationary or mobile devices of the like.

Much effort has been made by the industry to enhance media content consumption user experience. For example, recent media consumption devices, such as set-top boxes, or smartphones, often include support for voice and/or gesture commands. In the case of voice commands, typically a generic acoustic speech recognition model is provided to recognize speech in voice input. However, no matter how well trained the generic acoustic speech recognition model may be, it is often difficult recognize speeches of multiple users, using a generic acoustic speech recognition model. Thus, user experience of multi-user devices, such as television, is often less than ideal.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for media content distribution and consumption with acoustic user identification, and/or individualized acoustic speech recognition, in accordance with various embodiments.

FIG. 2 illustrates the example user interface engine of FIG. 1 in further detail, in accordance with various embodiments.

FIGS. 3 & 4 illustrate an example process for generating a voice print for a user, in accordance with various embodiments.

FIG. 5 illustrates an example process for processing user commands, in accordance with various embodiments.

FIG. 6 illustrates an example process for acoustic speech recognition using specifically trained acoustic speech recognition model of a user, in accordance with various embodiments.

FIG. 7 illustrates an example process for specifically training an acoustic speech recognition model for a user, in accordance with various embodiments.

FIG. 8 illustrates an example computing environment suitable for practicing the disclosure, in accordance with various embodiments.

FIG. 9 illustrates an example storage medium with instructions configured to enable an apparatus to practice the present disclosure, in accordance with various embodiments.

### DETAILED DESCRIPTION

Apparatuses, methods and storage medium associated with content consumption, are disclosed herein. In embodiments, an apparatus, e.g., a media player or a set-top box, may include a presentation engine to play the media content, e.g., a movie; and a user interface engine to facilitate a user in controlling the playing of the media content. The user interface engine may include a user identification engine to acoustically identify the user; an acoustic speech recognition engine to recognize speech in voice input of the user, using an acoustic speech recognition model specifically trained for the user, and a user command processing engine to process recognized speech as user commands. Resultantly, accuracy of speech recognition may be increased, and in turn, user experience may potentially be enhanced.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

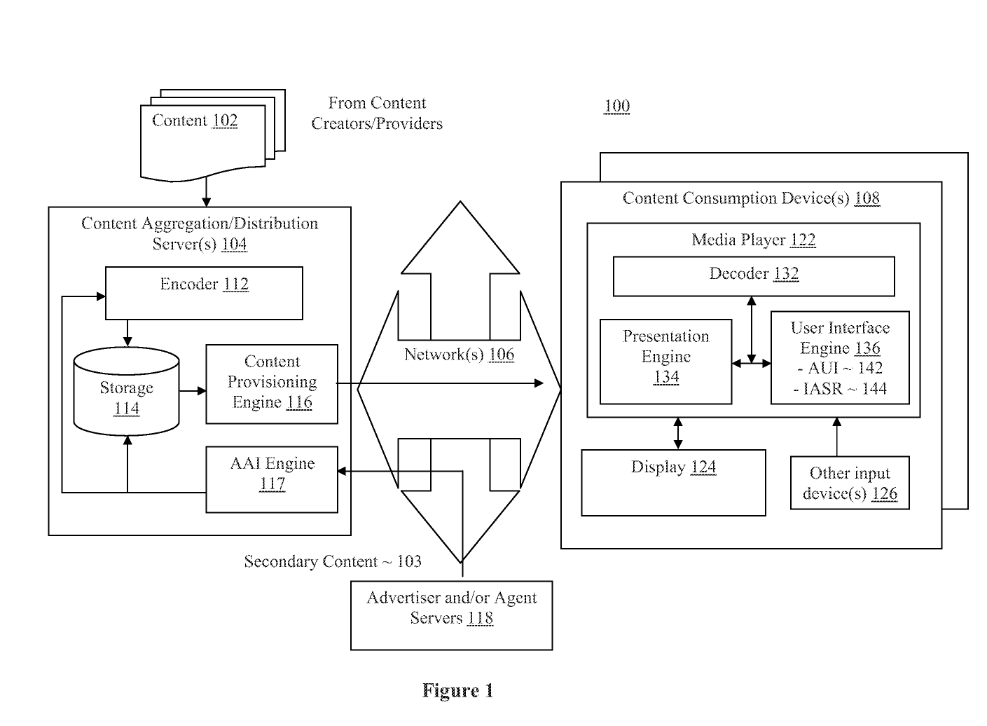

Referring now FIG. 1, wherein an arrangement for media content distribution and consumption with acoustic user identification and/or individualized acoustic speech recognition, in accordance with various embodiments, is illustrated. As shown, in embodiments, arrangement 100 for distribution and consumption of media content may include a number of content consumption devices 108 coupled with one or more content aggregation/distribution servers 104 via one or more networks 106. Content aggregation/distribution servers 104 may also be coupled with advertiser/agent servers 118, via one or more networks 106. Content aggregation/distribution servers 104 may be configured to aggregate and distribute media content 102, such as television programs, movies or web pages, to content consumption devices 108 for consumption, via one or more networks 106. Content aggregation/distribution servers 104 may also be configured to cooperate with advertiser/agent servers 118 to integrally or separately provide secondary content 103, e.g., commercials or advertisements, to content consumption devices 108. Thus, media content 102 may also referred to as primary content 102. Content consumption devices 108 in turn may be configured to play media content 102, and secondary content 103, for consumption by users of content consumption devices 108. In embodiments, content consumption devices 108 may include media player 122 configured to play media content 102 and secondary content 103, in response to requests and controls from the users. Further, media player 122 may include user interface engine 136 configured to facilitate the users in making requests and/or controlling the playing of primary and secondary content 102/103. In particular, user interface engine 136 may be configured to include acoustic user identification (AUI) 142 and/or individualized acoustic speech recognition (IASR) 144. Accordingly, incorporated with the acoustic user identification 142 and/or individualized acoustic speech recognition 144 teachings of the disclosure, arrangement 100 may provide more personalized, and thus, potentially enhanced user experience. These and other aspects will be described more fully below.

Continuing to refer to FIG. 1, in embodiments, as shown, content aggregation/distribution servers 104 may include encoder 112, storage 114, content provisioning engine 116, and advertiser/agent interface (AAI) engine 117, coupled with each other as shown. Encoder 112 may be configured to encode content 102 from various content providers. Encoder 112 may also be configured to encode secondary content 103 from advertiser/agent servers 118. Storage 114 may be configured to store encoded content 102. Similarly, storage 114 may also be configured to store encoded secondary content 103. Content provisioning engine 116 may be configured to selectively retrieve and provide, e.g., stream, encoded content 102 to the various content consumption devices 108, in response to requests from the various content consumption devices 108. Content provisioning engine 116 may also be configured to provide secondary content 103 to the various content consumption devices 108. Thus, except for its cooperation with content consumption devices 108, incorporated with the acoustic user identification and/or individualized acoustic speech recognition teachings of the present disclosure, content aggregation/distribution servers 104 are intended to represent a broad range of such servers known in the art. Examples of content aggregation/distribution servers 104 may include, but are not limited to, servers associated with content aggregation/distribution services, such as Netflix, Hulu, Comcast, Direct TV, Aereo, YouTube, Pandora, and so forth.

Contents 102, accordingly, may be media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth. As described earlier, secondary content 103 may be a broad range of commercials or advertisements known in the art.

In embodiments, for efficiency of operation, encoder 112 may be configured to transcode various content 102, and secondary content 103, typically in different encoding formats, into a subset of one or more common encoding formats. Encoder 112 may also be configured to transcode various content 102 into content segments, allowing for secondary content 103 to be presented in various secondary content presentation slots in between any two content segments. Encoding of audio data may be performed in accordance with, e.g., but are not limited to, the MP3 standard, promulgated by the Moving Picture Experts Group (MPEG), or the Advanced Audio Coding (AAC) standard, promulgated by the International Organization for Standardization (ISO). Encoding of video and/or audio data may be performed in accordance with, e.g., but are not limited to, the H264 standard, promulgated by the International Telecommunication Unit (ITU) Video Coding Experts Group (VCEG), or VP9, the open video compression standard promulgated by Google® of Mountain View, Calif.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning engine 116 may, in various embodiments, be configured to provide encoded media content 102, secondary content 103, as discrete files and/or as continuous streams. Content provisioning engine 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

In embodiments, AAI engine 117 may be configured to interface with advertiser and/or agent servers 118 to receive secondary content 103. On receipt, AAI engine 117 may route the received secondary content 103 to encoder 112 for transcoding as earlier described, and then stored into storage 114. Additionally, in embodiments, AAI engine 117 may be configured to interface with advertiser and/or agent servers 118 to receive audience targeting selection criteria (not shown) from sponsors of secondary content 103. Examples of targeting selection criteria may include, but are not limited to, demographic and interest of the users of content consumption devices 108. Further, AAI engine 117 may be configured to store the audience targeting selection criteria in storage 114, for subsequent use by content provisioning engine 116.

In embodiments, encoder 112, content provisioning engine 116 and AAI engine 117 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of content aggregation/distribution servers 104.

Still referring to FIG. 1, networks 106 may be any combination of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content aggregation/distribution servers' end or advertiser/agent servers' end, networks 106 may include one or more local area networks with gateways and firewalls, through which servers 104/118 go through to communicate with each other, and with content consumption devices 108. Similarly, at the content consumption end, networks 106 may include base stations and/or access points, through which content consumption devices 108 communicate with servers 104/118. In between the different ends, there may be any number of network routers, switches and other networking equipment of the like. However, for ease of understanding, these gateways, firewalls, routers, switches, base stations, access points and the like are not shown.

In embodiments, as shown, a content consumption device 108 may include media player 122, display 124 and other input device 126, coupled with each other as shown. Further, a content consumption device 108 may also include local storage (not shown). Media player 122 may be configured to receive encoded content 102, decode and recovered content 102, and present the recovered content 102 on display 124, in response to user selections/inputs from user input device 126. Further, media player 122 may be configured to receive secondary content 103, decode and recovered secondary content 103, and present the recovered secondary content 103 on display 124, at the corresponding secondary content presentation slots. Local storage (not shown) may be configured to store/buffer content 102, and secondary content 103, as well as working data of media player 122.

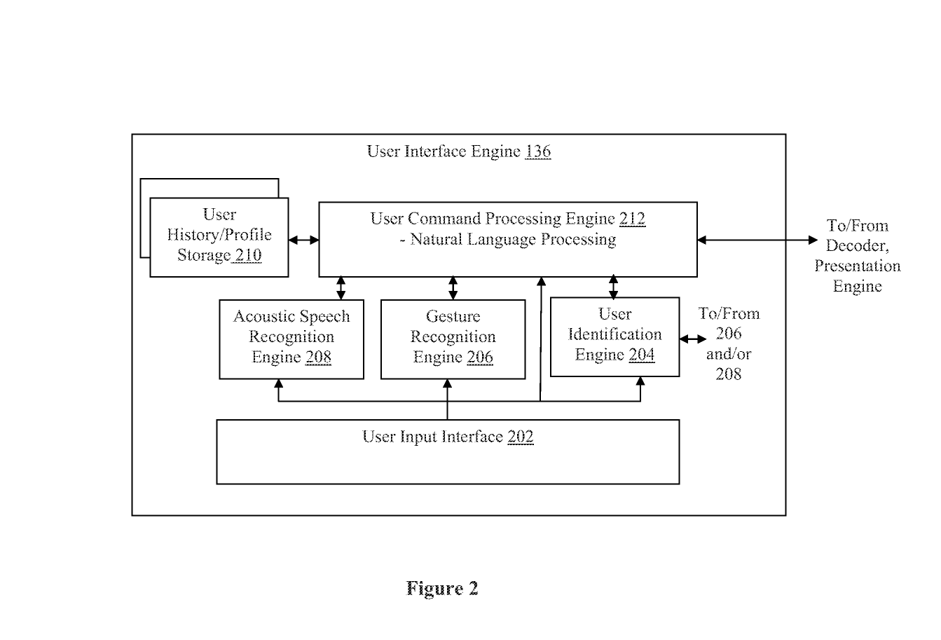

In embodiments, media player 122 may include decoder 132, presentation engine 134 and user interface engine 136, coupled with each other as shown. Decoder 132 may be configured to receive content 102, and secondary content 103, decode and recover content 102, and secondary content 103. Presentation engine 134 may be configured to present content 102 with secondary content 103 on display 124, in response to user controls, e.g., stop, pause, fast-forward, rewind, and so forth. User interface engine 136 may be configured to receive selections/controls from a content consumer (hereinafter, also referred to as the “user”), and in turn, provide the user selections/controls to decoder 132 and/or presentation engine 134. In particular, as earlier described, user interface engine 136 may include acoustic user identification (AUI) 142, and/or individualized acoustic speech recognition (IASR) 144, to be described later with references with FIGS. 2-7.

While shown as part of a content consumption device 108, display 124 and/or other input device(s) 126 may be standalone devices or integrated, for different embodiments of content consumption devices 108. For example, for a television arrangement, display 124 may be a stand-alone television set, Liquid Crystal Display (LCD), Plasma and the like, while player 122 may be part of a separate set-top set or a digital recorder, and other user input device 126 may be a separate remote control or keyboard. Similarly, for a desktop computer arrangement, media player 122, display 124 and other input device(s) 126 may all be separate stand alone units. On the other hand, for a laptop, ultrabook, tablet or smartphone arrangement, media player 122, display 124 and other input devices 126 may be integrated together into a single form factor. Further, for tablet or smartphone arrangement, a touch sensitive display screen may also server as one of the other input device(s) 126, and media player 122 may be a computing platform with a soft keyboard that also include one of the other input device(s) 126.

In embodiments, other input device(s) 126 may include a number of sensors configured to collect environment data for use in individualized acoustic speech recognition (144). For example, in embodiments, other input device(s) 126 may include a number of speakers and sensors configured to enable content consumption devices 108 to transmit and receive responsive optical and/or acoustic signals to characterize the room content consumption devices 108 is located. The signals transmitted may, e.g., be white noise or swept sine signals. The characteristics of the room may include, but are not limited to, impulse response attributes, ambient noise floor, or size of the room.

In embodiments, decoder 132, presentation engine 134 and user interface engine 136 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of content consumption devices 108. Thus, except for acoustic user identification (AUI) 142, and/or individualized acoustic speech recognition (IASR) 144, content consumption devices 108 are also intended to otherwise represent a broad range of these devices known in the art including, but are not limited to, media player, game console, and/or set-top box, such as Roku streaming player from Roku of Saratoga, Calif., Xbox, from Microsoft Corporation of Redmond, Wash., Wii from Nintendo of Kyoto, Japan, desktop, laptop or tablet computers, such as those from Apple Computer of Cupertino, Calif., or smartphones, such as those from Apple Computer or Samsung Group of Seoul, Korea.

Referring now to FIG. 2, wherein an example user interface engine 136 of FIG. 1 is illustrated in further detail, in accordance with various embodiments. As shown, in embodiments, user interface engine 136 may include user input interface 202, user identification engine 204, gesture recognition engine 206, acoustic speech recognition engine 208, user history/profile storage 210 and/or user command processing engine 212, coupled with each other. In embodiments, user input interface 202 may be configured to receive a broad range of electrical, optical, magnetic, tactile, and/or acoustic user inputs from a wide range of input devices, such as, but not limited to, keyboard, mouse, track ball, touch pad, touch screen, camera, microphones, and so forth. The received user inputs may be routed to user identification engine 204, gesture recognition engine 206, acoustic speech recognition engine 208, and/or user command processing engine 212, accordingly. For examples, acoustic inputs from microphones may be routed to user identification engine 204, and/or acoustic speech recognition engine 208, whereas optical/tactile and electrical/magnetic inputs may be routed to gesture recognition engine 206, acoustic speech recognition engine 208, and user command processing engine 212 respectively instead.

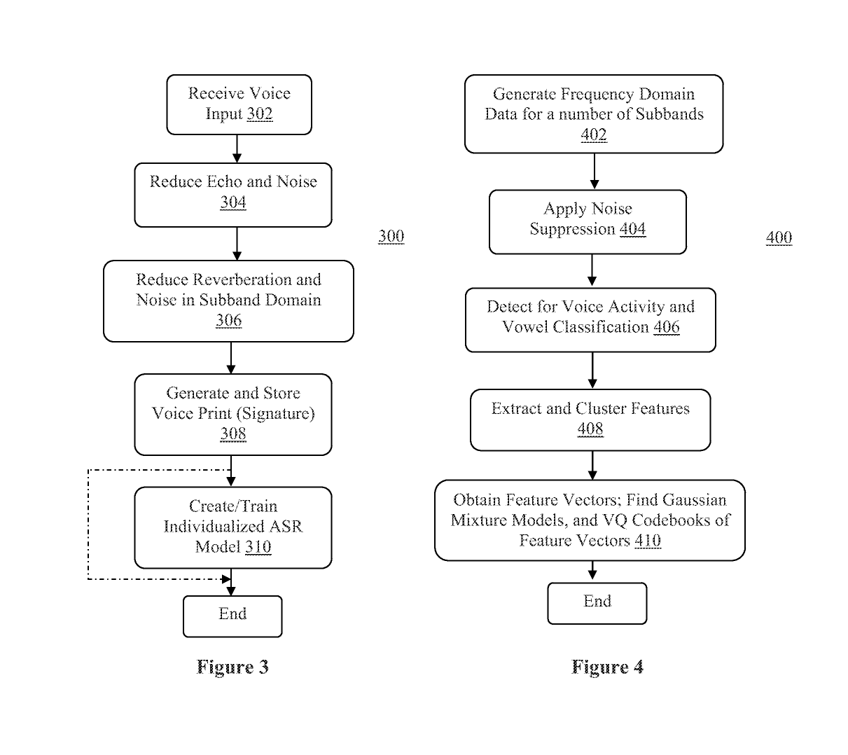

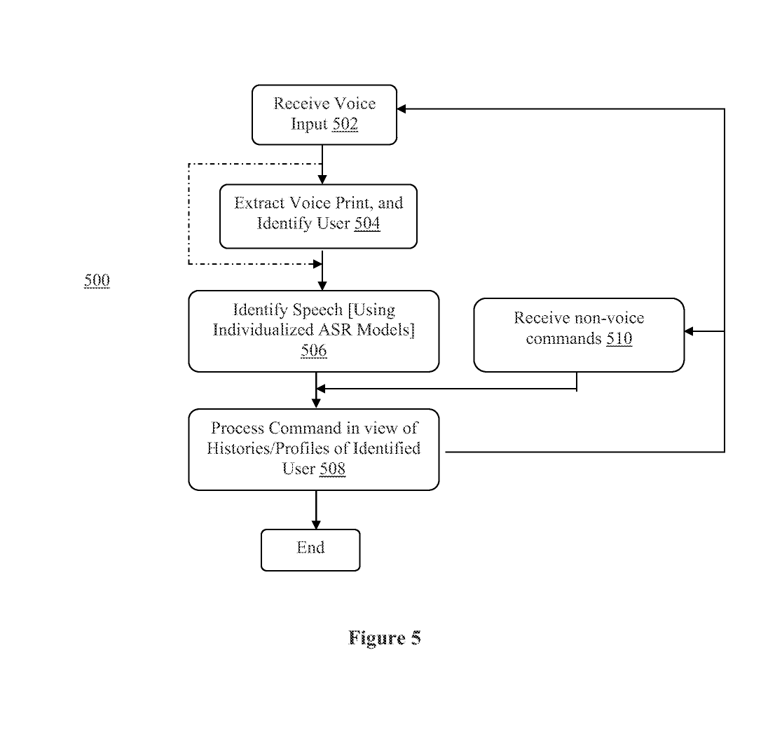

In embodiments, user identification engine 204 may be configured to provide acoustic user identification 142, acoustically identifying a user based on received voice inputs. User identification engine 204 may output an identification of the acoustically identified user to gesture recognition engine 206, acoustic speech recognition engine 208, and/or user command processing engine 212, to enable each of gesture recognition engine 206, acoustic speech recognition engine 208, and/or user command processing engine 212 to particularize the respective functions these engines 206/208/212 perform for the user acoustically identified, thereby potentially personalizing and enhancing the media content consumption experience. Acoustic identification of a user will be further described later with references to FIGS. 3-4, and particularized processing of user commands for the acoustically identified user will be further described later with references to FIG. 5.

Gesture recognition engine 206 may be configured to recognize user gestures from optical and/or tactile inputs and translate them into user commands for user command processing engine 212. In embodiments, gesture recognition engine 206 may be configured to employ individualized gesture recognition models to recognize user gestures and translate them into user commands, based at least in part on the user identification acoustically determined, thereby potentially enhancing the accuracy of the translated user commands, and in turn, the overall media content consumption experience.

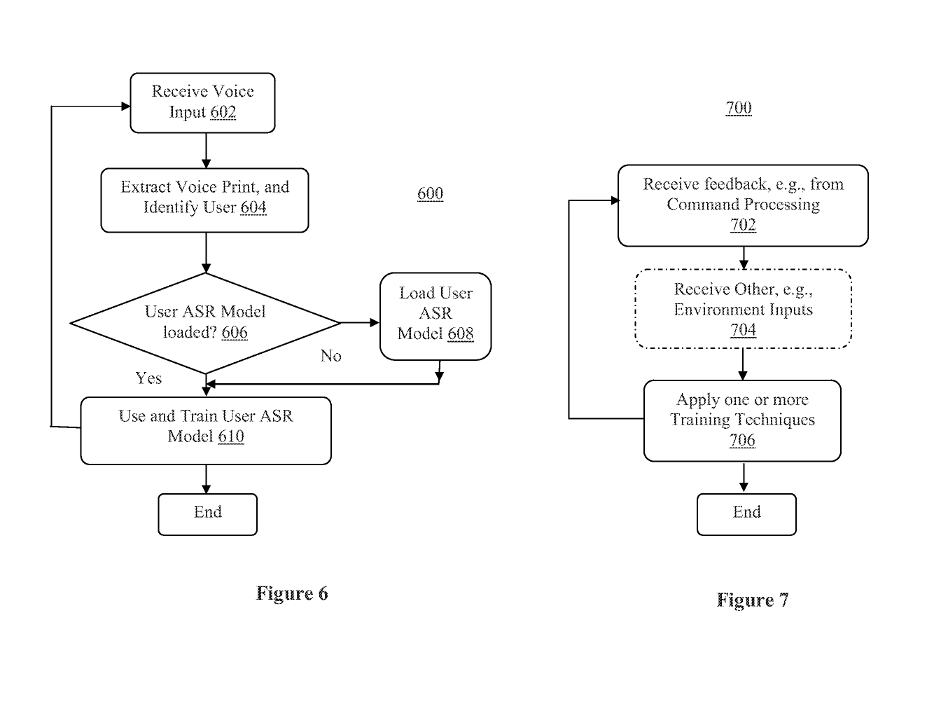

Similarly, in embodiments, acoustic speech recognition engine 208 may be configured to employ individualized acoustic speech recognition models to recognize user speech in user voice inputs, based at least in part on the user identification acoustically determined, thereby potentially enhancing the accuracy of the user speech recognized, and in turn, the accuracy of user command processing by user command processing engine 212, and the overall media content consumption experience. Acoustic speech recognition employing individualized acoustic speech recognition models will be further described later with references to FIG. 6.

User history/profile storage 210 may be configured to enable user command processing engine 212 to accumulate and store the histories and interests of the various users, for subsequent employment in its processing of user commands. Any one of a wide range of persistent, non-volatile storage may be employed including, but are not limited, non-volatile solid state memory.

User command processing engine 212 may be configured to process user commands, inputted directly through user input interface 202, e.g., from keyboard or cursor control devices, or indirectly as mapped/translated by gesture recognition engine 206 and/or acoustic speech recognition engine 208. In embodiments, as alluded to earlier, user command processing engine 212 may process user commands, based at least in part of the histories/profiles of the users acoustically identified. Further, user command processing engine 212 may include natural language processing capabilities to process speech recognized by acoustic speech recognition engine as user commands.

In embodiments, user input interface 202, user identification engine 204, gesture recognition engine 206, acoustic speech recognition engine 208, and/or user command processing engine 212 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of media player 122 and/or content consumption devices 108.

Further, it should be noted that while for ease of understanding, user input interface 202, user identification engine 204, gesture recognition engine 206, acoustic speech recognition engine 208, and/or user command processing engine 212 have been described as part of user interface engine 136 of media player 122, in alternate embodiments, one or more of these engines 204-208 and 212 may be distributed in other components of content consumption device 108. For example, user identification engine 204 may be located on a remote control of media player 122, or of content consumption devices 108 instead.

Referring now to FIGS. 3 and 4, wherein an example process of creating a reference user voice print, and/or an initial individualized acoustic speech recognition model is illustrated, in accordance with various embodiments. As shown, example process 300 for creating a reference user voice print, and/or an initial individualized acoustic speech recognition model may include operations performed in blocks 302-310. Example process 400 illustrates the operations of block 308 associated with generating a user voice print, in accordance with various embodiments. Example processes 300 and 400 may be performed, e.g., jointly by earlier described acoustic user identification engine 204, and individualized acoustic speech recognition engine 208 of user interface engine 136.

In embodiments, example processes 300 and 400 may be performed as part of a registration process to register a user with media player 122 and/or content consumption device 108. In embodiments, example processes 300 and 400 may be performed at the request of a user. In still other embodiments, example processes 300 and 400 may be performed at the request of user command processing engine 212, e.g., when the accuracy of responding to user commands appear to fall below a threshold.

As shown, process 300 may begin at block 302. At block 302, voice input of a user may be received. From block 302, process may proceed to block 304, then block 306. At block 304, the received voice input may be processed to reduce echo and/or noise in the voice input. In embodiments, echo and/or noise in the voice input may be reduced, e.g., by applying beamforming using a plurality of microphones, and/or echo cancellation. At block 306, the received voice input may also be processed to reduce reverberation and/or noise in the subband domain of the voice input.

From block 306, process 300 may proceed to block 308. At block 308, a reference voice print of the user may be generated and stored. The reference voice print may also be referred to as the voice signature of the user. In embodiments (those that support individualized acoustic speech recognition), from block 308, process 300 may proceed to block 310. At block 310, an individualized acoustic speech recognition model may be created, e.g., from a generic acoustic speech recognition model, if one does not already exist, and specifically trained for the user. From block 310, process 300 may end. As denoted by the dotted line connecting block 308 and the “end” block, for embodiments that do not include individualized acoustic speech recognition, process 300 may end after block 308. In other words, block 310 may be optional.

As shown, process 400 for generating a voice print may begin at block 402. At block 402, frequency domain data for a number of subbands may be generated from the time domain data of received voice input (optionally, with echo and noise, as well as reverberation in subband domain reduced). The frequency domain data may be generated, e.g., by applying filterbank to the time domain data. From block 402, process 400 may proceed to block 404. At block 404, process 400 may apply noise suppression to the frequency domain data.

From block 404, process 400 may proceed to block 406. At block 406, the frequency domain data (optionally, with noise suppressed) may be analyzed to detect for voice activity. Further, on detection of voice activity, vowel classification may be performed. From block 406, process 400 may proceed to block 408. At block 408, features may be extracted from the frequency domain data, and clustered, based at least in part on the result of the voice activity detection and vowel classification. From block 408, process 400 may proceed to block 410. At block 410, feature vectors may be obtained. In embodiments, the feature vectors may be obtained by applying discrete cosine transform (DCT) to the sum of the log domain subbands of the frequency domain data. Further, at block 410, the Gaussian mixture models (GMM) and vector quantization (VQ) codebooks of the feature vectors may be obtained. From block 410, process 400 may end.

Referring now to FIG. 5, wherein an example process for processing of user commands during consumption of media content, in accordance with various embodiments, is illustrated. As shown, process 500 for processing of user commands during consumption of media content may include operations in blocks 502-508. The operations in blocks 502-508 may be performed, e.g., by earlier described user command processing engine 212.

As shown, process 500 may begin at block 502. At block 502, user voice input may be received. From block 502, process 500 may proceed to block 504. At block 504, voice print may be extracted, and compared to stored reference user voice prints to identify the user. Extraction of the voice print during operation may be similarly performed as earlier described for generation of the reference voice print. That is, extraction of voice print during operation may likewise include the reduction of echo and noise, as well as reverberation in subbands of the voice input; and generation of voice print may include obtaining GMM and VQ codebooks of feature vectors extracted from frequency domain data, obtained from the time domain data of the voice input. As earlier described, on identification of the user, a user identification may be outputted by the identifying component, e.g., acoustic user identification engine 204, for use by other components.

From block 506, process 500 may proceed to block 506. At block 506, user speech may be identified from the received voice input. In embodiments, the speech may be identified using an individualized and specifically trained acoustic speech recognition model of the identified user. From block 506, process 500 may proceed to block 508. At block 508, the identified speech may be processed as user commands. The processing of the user commands may be based at least in part on the history and profile of the acoustically identified user. For example, if the speech was identified as the user asking for “the latest movies,” the user command may nonetheless be processed in view of the history and profile of the identified user, with the response being returned ranked by (or including only) movies of the genres of interest to the users, or permitted for minor users under current parental control setting. Thus, the consumption of media content may be personalized, and the user experience for consuming media content may be potentially enhanced.

From block 508, process 500 may proceed to block 510 or return to block 502. At block 510, other non-voice commands, such as keyboard, cursor control or user gestures may be received. From block 510, process 500 may return to block 508. Once the user has been identified, the subsequent non-voice commands may likewise be processed based at least in part on the history/profile of the user acoustically identified. If returned to block 502, process 500 may proceed as earlier described. However, in embodiments, the operations at block 504, that is, extraction of voice print and identification of the user, may be skipped and repeated periodically, as opposed to continuously, as denoted by the dotted arrow bypassing block 504.

Process 500 may so repeat itself, until consumption of media content has been completed, e.g., on processing of a “stop play” or “power off” command from the user, while at block 508. From there, process 500 may end.

Referring now to FIG. 6, wherein an example process for specifically training an acoustic speech recognition model for a user, in accordance with various embodiments, is shown. As illustrated, process 600 for specifically training an acoustic speech recognition model for a user, may include operations performed in blocks 602-610. In embodiments, the operations may be performed, e.g., jointly by earlier described acoustic user identification engine 204 and individualized acoustic speech recognition engine 208.

Process 600 may start at block 602. At block 602, voice input may be received from the user. From block 602, process 600 may proceed to block 604. At block 604, a voice print of the user may be extracted based on the voice input received, and the user acoustically identified. Extraction of the user voice print and acoustical identification of the user may be performed as earlier described.

From block 604, process 600 may proceed to block 606. At block 606, a determination may be made on whether the current acoustic speech recognition model is an acoustic speech recognition model specifically trained for the user. If the result of the determination is negative, process 600 may proceed to block 608. At block 608, an acoustic speech recognition model being specifically trained for the user may be loaded. If no acoustic speech recognition model has been specifically trained for the user thus far, a new instance of an acoustic speech model may be created to be specifically trained for the user.

On determination that the current acoustic speech recognition model is specifically trained for the user at block 606, or on loading an acoustic speech recognition model specifically trained for the user at block 608, process 600 may proceed to block 610. At block 610, the current acoustic speech recognition model, specifically trained for the user, may be used to recognized speech in the voice input, and trained for the user, to be described more fully later with references to FIG. 7.

From block 610, process 600 may return to block 602, where further user voice input may be received. From block 602, process 600 may proceed as earlier described. Eventually, at termination of consumption of media content, e.g., on receipt of a “stop play” or “power off” command, from block 610, process 600 may end.

Referring now to FIG. 7, wherein an example process for specifically training an acoustic speech recognition model for a user, in accordance with various embodiments, is shown. As illustrated, process 700 for specifically training an acoustic speech recognition model for a user may include operations performed in block 702-706. The operations may be performed, e.g., by earlier described individualized acoustic speech recognition engine 208.

Process 700 may start at block 702. At block 702, feedback may be received, e.g., from command processing which processed the recognized speech as user commands for media content consumption. Given the specific context of commanding media content consumption, natural language command processing has a higher likelihood of successfully/accurately processing the recognized speech as user commands. From block 702, process 700 may proceed to optional block 704 (as denoted by the dotted boundary line). At block 704, process 700 may further receive additional inputs, e.g., environment data. As earlier described, in embodiments, input devices 126 of a media content consumption device 108 may include a number of sensors, including sensors configured to provide environment data, e.g., sensors that can optically and/or acoustically determine the size of the room media content consumption device 108 is located. Examples other data may also include the strength/volume of the voice input received, denoting proximity of the user to the microphones receiving the voice inputs.

From block 704, process 700 may proceed to block 706. At block 706, a number of training techniques may be applied to specifically train the acoustic speech recognition model for the user, based at least in part on the feedback from user command processing and/or environment data. For example, in embodiment, training may involve, but are not limited to, application and/or usage of hidden Markov model, maximum likelihood estimation, discrimination techniques, maximizing mutual information, minimizing word errors, minimizing phone errors, maximum a posteriori (MAP), and/or maximum likelihood linear regression (MLLR).

In embodiments, the individualized training process may start with selecting a best fit baseline acoustic model for a user, from a set of diverse acoustic models pre-trained offline to capture different groups of speakers with different accents and speaking style in different acoustic environments. In embodiments, 10 to 50 of such acoustic models may be pre-trained offline, and made available for selection (remotely or on content consumption device 108). The best fit baseline acoustic model may be the model which gives the highest average confidence levels or the smallest word error rate or phone error rate for the case of supervised learning where known text is read by the user or feedback is available to confirm the commands. If environment data is not received, the individualized acoustic model may be adapted from the selected best fit baseline acoustic model, using e.g., selected ones of the above mentioned techniques, such as MAP or MLLR, to generate the individual acoustic speech recognition model for the user.

In embodiments, where environment data, such as room impulse response and ambient noise, and so forth, are available, the environment data may be employed to adapt the selected best fit baseline acoustic model to further compensate for the differences of the acoustic environments where content consumption device 108 operates, and the training data are captured, before the selected best fit baseline acoustic model is further adapted to generate the individual acoustic speech recognition model for the user. In embodiments, the environment adapted acoustic model may be obtained by creating preprocessed training data, convolving the stored audio signals with estimated room impulse response, and adding the generated or captured ambient noise to the convolved signals. Thereafter, the preprocessed training data may be employed to adapt the model with selected ones of the above mentioned techniques, such as MAP or MLLR, to generate the individual acoustic speech recognition model for the user.

From block 706, process 700 may return to block 702, where further feedback may be received. From block 702, process 700 may proceed as earlier described. Eventually, at termination of consumption of media content, e.g., on receipt of a “stop play” or “power off” command, from block 706, process 700 may end.

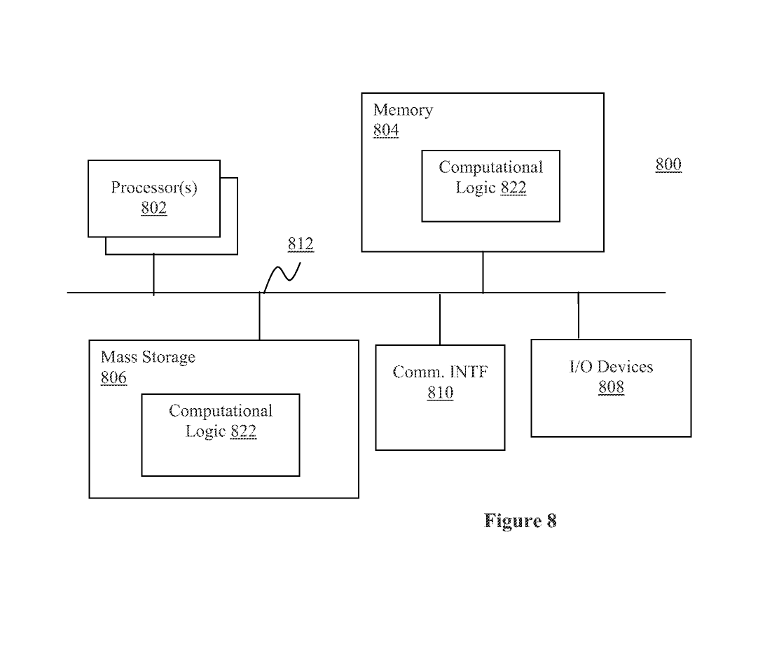

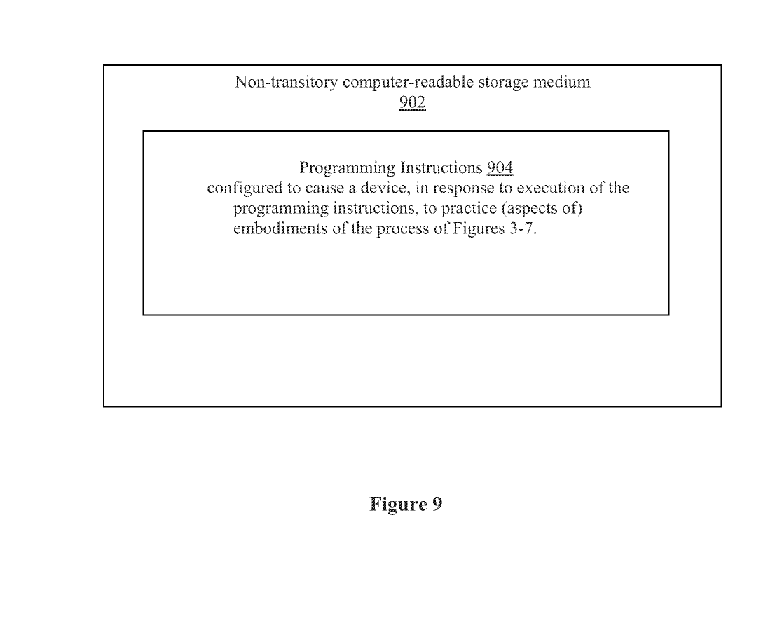

Referring now to FIG. 8, wherein an example computer suitable for use for the arrangement of FIG. 1, in accordance with various embodiments, is illustrated. As shown, computer 800 may include one or more processors or processor cores 802, and system memory 804. For the purpose of this application, including the claims, the terms “processor” and “processor cores” may be considered synonymous, unless the context clearly requires otherwise. Additionally, computer 800 may include mass storage devices 806 (such as diskette, hard drive, compact disc read only memory (CD-ROM) and so forth), input/output devices 808 (such as display, keyboard, cursor control and so forth) and communication interfaces 810 (such as network interface cards, modems and so forth). The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage devices 806 may be employed to store a working copy and a permanent copy of the programming instructions implementing the operations associated with acoustic user identification and/or individualized trained acoustic speech recognition, earlier described, collectively referred to as computational logic 822. The various elements may be implemented by assembler instructions supported by processor(s) 802 or high-level languages, such as, for example, C, that can be compiled into such instructions.

The permanent copy of the programming instructions may be placed into permanent storage devices 806 in the factory, or in the field, through, for example, a distribution medium (not shown), such as a compact disc (CD), or through communication interface 810 (from a distribution server (not shown)). That is, one or more distribution media having an implementation of the agent program may be employed to distribute the agent and program various computing devices.

The number, capability and/or capacity of these elements 810-812 may vary, depending on whether computer 800 is used as a content aggregation/distribution server 104, a content consumption device 108, or an advertiser/agent server 118. When use as content consumption device 108, the capability and/or capacity of these elements 810-812 may vary, depending on whether the content consumption device 108 is a stationary or mobile device, like a smartphone, computing tablet, ultrabook or laptop. Otherwise, the constitutions of elements 810-812 are known, and accordingly will not be further described.

FIG. 9 illustrates an example computer-readable non-transitory storage medium having instructions configured to practice all or selected ones of the operations associated with earlier described content consumption devices 108, in accordance with various embodiments. As illustrated, non-transitory computer-readable storage medium 902 may include a number of programming instructions 904. Programming instructions 904 may be configured to enable a device, e.g., computer 800, in response to execution of the programming instructions, to perform, e.g., various operations of processes 300-700 of FIGS. 3-7, e.g., but not limited to, the operations associated with acoustic user identification and/or individualized acoustic speech recognition. In alternate embodiments, programming instructions 904 may be disposed on multiple computer-readable non-transitory storage media 902 instead. In alternate embodiments, programming instructions 904 may be disposed on computer-readable transitory storage media 902, such as, signals.

Referring back to FIG. 8, for one embodiment, at least one of processors 802 may be packaged together with memory having computational logic 822 (in lieu of storing on memory 804 and storage 806). For one embodiment, at least one of processors 802 may be packaged together with memory having computational logic 822 to form a System in Package (SiP). For one embodiment, at least one of processors 802 may be integrated on the same die with memory having computational logic 822. For one embodiment, at least one of processors 802 may be packaged together with memory having computational logic 822 to form a System on Chip (SoC). For at least one embodiment, the SoC may be utilized in, e.g., but not limited to, a set-top box.

Thus various example embodiments of the present disclosure have been described including, but are not limited to:

Example 1 may be an apparatus for playing media content. The apparatus may include a presentation engine to play the media content; and a user interface engine coupled with the presentation engine to facilitate a user in controlling the playing of the media content. The user interface engine may include a user identification engine to acoustically identify and output an identification of the user; and an acoustic speech recognition engine coupled with the user identification engine to recognize speech in voice input of the user, using an acoustic speech recognition model specifically trained for the user, based at least in part on the identification of the user outputted by the user identification engine. Further, the user interface engine may include a user command processing engine coupled with the acoustic speech recognition engine to process acoustic speech recognized by the acoustic speech recognition engine, using the acoustic speech recognition model specifically trained for the user, as acoustically provided natural language commands of the user.

Example 2 may be example 1, wherein the acoustic speech recognition engine is to: receive the identification of the user outputted by the user identification engine; determine whether a current acoustic speech recognition model in use to recognize speech in voice input is specifically trained for the user as identified by the identification received; and on determination that the current acoustic speech recognition model in use to recognize speech in voice input is not specifically trained for the user as identified by the identification received, loading an acoustic speech recognition model that is specifically trained for the user to become the current acoustic speech recognition model for use to recognize speech in voice input.

Example 3 may be example 2, wherein the acoustic speech recognition engine is to further receive voice input from the user, and specifically train an acoustic speech recognition model for the user.

Example 4 may be example 3, wherein the acoustic speech recognition engine is to receive the voice input from the user, and specifically train an acoustic speech recognition model for the user, as part of a registration process.

Example 5 may be example 3 or 4, wherein the acoustic speech recognition engine is to receive the voice input from the user, and specifically train an acoustic speech recognition model for the user, as part of recognizing acoustic speech in the voice input.

Example 6 may be any one of examples 3-5, wherein the acoustic speech recognition engine is to further reduce echo or noise in the voice input, and wherein specifically train an acoustic speech recognition model for the user is based at least in part on the voice input of the user, with echo or noise reduced.

Example 7 may be any one of examples 3-6, wherein the acoustic speech recognition engine is to further reduce reverberation or noise in the voice input in a subband domain, and wherein specifically train an acoustic speech recognition model for the user is based at least in part on the voice input of the user, with reverberation or noise reduced in the subband domain.

Example 8 may be any one of examples 3-7, wherein the acoustic speech recognition engine is to receive feedback from the user command processing engine, and wherein specifically train an acoustic speech recognition model for the user is further based at least in part on the feedback received from the user command processing engine.

Example 9 may be any one of examples 3-8, wherein the acoustic speech recognition engine is to receive environmental data associated with an environment of the apparatus, and wherein specifically train an acoustic speech recognition model for the user is further based at least in part on the environmental data.

Example 10 may be example 9, further having one or more sensors to collect the environmental data.

Example 11 may be example 10, wherein the one or more sensors include one or more acoustic transceivers to send and receive acoustic signals to estimate spatial dimensions of the environment.

Example 12 any one of examples 1-11, wherein the user command processing engine is further coupled with the user identification engine to process commands of the user in view of user history or profile of the user identified.

Example 13 may be example 12, wherein the apparatus may include a selected one of a media player, a smartphone, a computing tablet, a netbook, an e-reader, a laptop computer, a desktop computer, a game console, or a set-top box.

Example 14 may be at least one storage medium having instructions to be executed by a media content consumption apparatus to cause the apparatus, in response to execution of the instructions by the apparatus, to acoustically identify a user of the apparatus, recognize speech in a voice input by the user, using acoustic speech recognition model specifically trained for the user, and process the recognized speech as user command to control playing of a media content.

Example 15 may be example 14, wherein the apparatus is further caused to: determine whether a current acoustic speech recognition model in use to recognize speech in voice input is specifically trained for the acoustically identified user; and on determination that the current acoustic speech recognition model in use to recognize speech in voice input is not specifically trained for the acoustically identified, loading an acoustic speech recognition model that is specifically trained for the acoustically identified user to become the current acoustic speech recognition model for use to recognize speech in voice input.

Example 16 may be example 15, wherein the apparatus is further caused to receive voice input from the user, and specifically train an acoustic speech recognition model for the acoustically identified user.

Example 17 may be example 16, wherein the apparatus is further caused to receive the voice input from the user, and specifically train an acoustic speech recognition model for the user, as part of a registration process.

Example 18 may be example 16 or 17, wherein he apparatus is further caused to receive the voice input from the user, and specifically train an acoustic speech recognition model for the user, as part of recognizing acoustic speech in the voice input.

Example 19 may be any one of examples 16-18, wherein the apparatus is further caused to receive feedback user command processing, and wherein specifically train an acoustic speech recognition model for the user is further based at least in part on the feedback received from user command processing.

Example 20 may be any one of claims 16-19, wherein the apparatus is further caused to receive environmental data associated with an environment of the apparatus, and wherein specifically train an acoustic speech recognition model for the user is further based at least in part on the environmental data.

Example 21 may be example 20, further having one or more sensors to collect the environmental data, including one or more acoustic transceivers to send and receive acoustic signals to estimate spatial dimensions of the environment.

Example 22 may be a method for consuming content. The method may include playing, by a content consumption device, media content; and facilitating a user, by the content consumption device, in controlling the playing of the media content. Facilitating a user may include acoustically identifying, by the content consumption device, a user of the content consumption device; recognizing, by the content consumption device, speech in a voice input by the user, using acoustic speech recognition model specifically trained for the user, and processing, by the content consumption device, the recognized speech as user command to control playing of a media content.

Example 23 may be example 22, further having: determining, by the content consumption device, whether a current acoustic speech recognition model in use to recognize speech in voice input is specifically trained for the acoustically identified user; and on determination that the current acoustic speech recognition model in use to recognize speech in voice input is not specifically trained for the acoustically identified, loading, by the content consumption device, an acoustic speech recognition model that is specifically trained for the acoustically identified user to become the current acoustic speech recognition model for use to recognize speech in voice input.

Example 24 may be example 22 or 23, further having specifically training, by the content consumption device, an acoustic speech recognition model for the acoustically identified user, as part of a registration process, or as part of recognizing acoustic speech in the voice input.

Example 25 may be example 24, wherein specifically training an acoustic speech recognition model for the user may include specifically training an acoustic speech recognition model for the user based at least in part on feedback received from processing speech recognized as user commands to control playing of the media content, or environmental data.

Example 26 may be example 24, wherein specifically training an acoustic speech recognition model for the user may include specifically training an acoustic speech recognition model for the user based at least in part on environmental data of the content consumption device.

Example 27 may be an apparatus for consuming content. The apparatus may include means for playing media content; and means for facilitating a user in controlling the playing of the media content. Means for facilitating may include means for acoustically identifying a user of the apparatus; means for recognizing speech in a voice input by the user, using acoustic speech recognition model specifically trained for the user, and means for processing the recognized speech as user command to control playing of a media content.

Example 28 may be apparatus 27, further having: means for determining whether a current acoustic speech recognition model in use to recognize speech in voice input is specifically trained for the acoustically identified user; and means for, on determination that the current acoustic speech recognition model in use to recognize speech in voice input is not specifically trained for the acoustically identified, loading an acoustic speech recognition model that is specifically trained for the acoustically identified user to become the current acoustic speech recognition model for use to recognize speech in voice input.

Example 29 may be example 27 or 28, further having means for specifically training an acoustic speech recognition model for the acoustically identified user, as part of a registration process, or as part of recognizing acoustic speech in the voice input.

Example 30 may be example 29, wherein means specifically training an acoustic speech recognition model for the user may include means for specifically training an acoustic speech recognition model for the user based at least in part on feedback received from processing speech recognized as user commands to control playing of the media content, or environmental data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for playing media content, comprising:
a presentation engine to play the media content; and
a user interface engine coupled with the presentation engine to facilitate a user in controlling the playing of the media content;
wherein the user interface engine includes
a user identification engine to acoustically identify and output an identification of the user;
an acoustic speech recognition engine coupled with the user identification engine to recognize speech in voice input of the user, using an acoustic speech recognition model specifically trained for the user, based at least in part on the identification of the user outputted by the user identification engine; and
a user command processing engine coupled with the acoustic speech recognition engine to process acoustic speech recognized by the acoustic speech recognition engine, using the acoustic speech recognition model specifically trained for the user, as acoustically provided natural language commands of the user.

2. The apparatus of claim 1, wherein the acoustic speech recognition engine is to:
receive the identification of the user outputted by the user identification engine;
determine whether a current acoustic speech recognition model in use to recognize speech in voice input is specifically trained for the user as identified by the identification received; and
on determination that the current acoustic speech recognition model in use to recognize speech in voice input is not specifically trained for the user as identified by the identification received, loading an acoustic speech recognition model that is specifically trained for the user to become the current acoustic speech recognition model for use to recognize speech in voice input.

3. The apparatus of claim 2, wherein the acoustic speech recognition engine is to further receive voice input from the user, and specifically train an acoustic speech recognition model for the user.

4. The apparatus of claim 3, wherein the acoustic speech recognition engine is to receive the voice input from the user, and specifically train an acoustic speech recognition model for the user, as part of a registration process.

5. The apparatus of claim 3, wherein the acoustic speech recognition engine is to receive the voice input from the user, and specifically train an acoustic speech recognition model for the user, as part of recognizing acoustic speech in the voice input.

6. The apparatus of claim 3, wherein the acoustic speech recognition engine is to further reduce echo or noise in the voice input, and wherein specifically train an acoustic speech recognition model for the user is based at least in part on the voice input of the user, with echo or noise reduced.

7. The apparatus of claim 3, wherein the acoustic speech recognition engine is to further reduce reverberation or noise in the voice input in a subband domain, and wherein specifically train an acoustic speech recognition model for the user is based at least in part on the voice input of the user, with reverberation or noise reduced in the subband domain.

8. The apparatus of claim 3, wherein the acoustic speech recognition engine is to receive feedback from the user command processing engine, and wherein specifically train an acoustic speech recognition model for the user is further based at least in part on the feedback received from the user command processing engine.

9. The apparatus of claim 3, wherein the acoustic speech recognition engine is to receive environmental data associated with an environment of the apparatus, and wherein specifically train an acoustic speech recognition model for the user is further based at least in part on the environmental data.

10. The apparatus of claim 9, further comprising one or more sensors to collect the environmental data.

11. The apparatus of claim 10, wherein the one or more sensors include one or more acoustic transceivers to send and receive acoustic signals to estimate spatial dimensions of the environment.

12. The apparatus of claim 1, wherein the user command processing engine is further coupled with the user identification engine to process commands of the user in view of user history or profile of the user identified.

13. The apparatus of claim 1, wherein the apparatus comprises a selected one of a media player, a smartphone, a computing tablet, a netbook, an e-reader, a laptop computer, a desktop computer, a game console, or a set-top box.

14. At least one storage medium comprising instructions to be executed by a media content consumption apparatus to cause the apparatus, in response to execution of the instructions by the apparatus, to acoustically identify a user of the apparatus, recognize speech in a voice input by the user, using acoustic speech recognition model specifically trained for the user, and process the recognized speech as user command to control playing of a media content.

15. The storage medium of claim 14, wherein the apparatus is further caused to:
determine whether a current acoustic speech recognition model in use to recognize speech in voice input is specifically trained for the acoustically identified user; and
on determination that the current acoustic speech recognition model in use to recognize speech in voice input is not specifically trained for the acoustically identified, loading an acoustic speech recognition model that is specifically trained for the acoustically identified user to become the current acoustic speech recognition model for use to recognize speech in voice input.

16. The storage medium of claim 15, wherein the apparatus is further caused to receive voice input from the user, and specifically train an acoustic speech recognition model for the acoustically identified user.

17. The storage medium of claim 16, wherein the apparatus is further caused to receive the voice input from the user, and specifically train an acoustic speech recognition model for the user, as part of a registration process.

18. The storage medium of claim 16, wherein he apparatus is further caused to receive the voice input from the user, and specifically train an acoustic speech recognition model for the user, as part of recognizing acoustic speech in the voice input.

19. The storage medium of claim 16, wherein the apparatus is further caused to receive feedback user command processing, and wherein specifically train an acoustic speech recognition model for the user is further based at least in part on the feedback received from user command processing.

20. The storage medium of claim 16, wherein the apparatus is further caused to receive environmental data associated with an environment of the apparatus, and wherein specifically train an acoustic speech recognition model for the user is further based at least in part on the environmental data.

21. The storage medium of claim 20, further comprising one or more sensors to collect the environmental data, including one or more acoustic transceivers to send and receive acoustic signals to estimate spatial dimensions of the environment.

22. A method for consuming content, comprising:
playing, by a content consumption device, media content; and
facilitating a user, by the content consumption device, in controlling the playing of the media content, including
acoustically identifying, by the content consumption device, a user of the apparatus;
recognizing, by the content consumption device, speech in a voice input by the user, using acoustic speech recognition model specifically trained for the user, and
processing, by the content consumption device, the recognized speech as user command to control playing of a media content.

23. The method of claim 22, further comprising:
determining, by the content consumption device, whether a current acoustic speech recognition model in use to recognize speech in voice input is specifically trained for the acoustically identified user; and
on determination that the current acoustic speech recognition model in use to recognize speech in voice input is not specifically trained for the acoustically identified, loading, by the content consumption device, an acoustic speech recognition model that is specifically trained for the acoustically identified user to become the current acoustic speech recognition model for use to recognize speech in voice input.

24. The method of claim 22, further comprising specifically training, by the content consumption device, an acoustic speech recognition model for the acoustically identified user, as part of a registration process, or as part of recognizing acoustic speech in the voice input.

25. The method of claim 24, wherein specifically training an acoustic speech recognition model for the user comprises specifically training an acoustic speech recognition model for the user based at least in part on feedback received from processing speech recognized as user commands to control playing of the media content, or environmental data of the content consumption device.
